(19) United States
(12) Patent Application Publication
(10) Pub. No.: US 2025/0100341 A1
(43) Pub. Date: Mar. 27, 2025

(54) AIR CONDITIONING SYSTEM OF DOUBLE-DECKER VEHICLE, AND DOUBLE-DECKER VEHICLE

(71) Applicant: BYD COMPANY LIMITED, SHENZHEN (CN)

(72) Inventors: Yuting HUANG, Shenzhen (CN); Xubei JI, Shenzhen (CN); Yanan PAN, Shenzhen (CN); Shiyi ZHAO, Shenzhen (CN); Wen LIN, Shenzhen (CN)

(21) Appl. No.: 18/974,604

(22) Filed: Dec. 9, 2024

Related U.S. Application Data
(63) Continuation of application No. PCT/CN2023/078409, filed on Feb. 27, 2023.

(30) Foreign Application Priority Data
Jun. 13, 2022 (CN) 202221482199.2

(51) Int. Cl. B60H 1/00; F24F 13/06

(52) U.S. Cl. CPC B60H 1/00021; B60H 1/00357; F24F 13/06; B60H 2001/00078

(57) ABSTRACT

An air conditioning system includes: an air conditioner box, an upper deck main air duct, and two upper deck transition air ducts. The air conditioner box is disposed on a body of a double-deck vehicle, and includes two upper deck air outlets. The upper deck main air duct is disposed at a top of an upper deck of the body of the double-deck vehicle, and includes two upper deck air inlets. The two upper deck air outlets and the two upper deck air inlets are staggered in a horizontal direction. Each of the two upper deck transition air ducts is communicated with one of the two upper deck air outlets and one of the two upper deck air inlets. Inner walls of the two upper deck transition air ducts are in smooth transition with inner walls of the two upper deck air outlets and the two upper deck air inlets.

### CROSS-REFERENCE TO RELATED APPLICATIONS

This application is a continuation application of International Patent Application No. PCT/CN2023/078409, filed on Feb. 27, 2023, which is based on and claims priority to and benefits of Chinese Patent Application No. 202221482199.2, filed on Jun. 13, 2022. The entire content of all of the above-referenced applications is incorporated herein by reference.

### FIELD

The present disclosure relates to the field of double-deck vehicle, and in particular, to an air conditioning system of double-deck vehicle and double-deck vehicle.

### BACKGROUND

At present, an air conditioning system is often arranged in the vehicle, and air is supplied to upper and lower deck of the vehicle through the air conditioning system. In the related art, when there is a large glass area on the upper deck, cooling the upper deck of a vehicle is difficult, and the air supply effect is poor, such that the air supply demand for the upper deck cannot be met.

### SUMMARY

The present disclosure is to provide a new technical solution for an air conditioning system of double-deck vehicle and double-deck vehicle.

According to a first aspect of the present disclosure, there is provided an air conditioning system of a double-deck vehicle, the air conditioning system of a double-deck vehicle includes:

an air conditioner box disposed on a body of the double-deck vehicle, and comprising two upper deck air outlets;

an upper deck main air duct disposed at a top of an upper deck of the body of the double-deck vehicle, the upper deck main air duct comprises two upper deck air inlets, and the two upper deck air outlets and the two upper deck air inlets staggered in a horizontal direction;

two upper deck transition air ducts, each of the two upper deck transition air ducts communicated with one of the two upper deck air outlets and one of the two upper deck air inlets;

and

inner walls of the two upper deck transition air ducts being in smooth transition with inner walls of the two upper deck air outlets and inner walls of the two upper deck air inlets.

In an embodiment, a cross section of each of the two upper deck transition air ducts is substantially a rectangle, and a minimum curvature radius of each of four corners of the rectangle is about 25 mm;

each of the two upper deck transition air ducts comprises a first pipe section, a second pipe section, and a third pipe section, the first pipe section is communicated with one of the two upper deck air outlets, and the third pipe section is communicated with one of the two upper deck air inlets;

the first pipe section comprises a first arc-shaped pipe wall and a second arc-shaped pipe wall opposite to each other, a minimum curvature radius of the first arc-shaped pipe wall is about 6 mm, a minimum curvature radius of the second arc-shaped pipe wall is about 382 mm;

the second pipe section comprises a third pipe wall and a fourth pipe wall opposite to each other, the third pipe wall comprises a third arc-shaped pipe wall located on a first end of the first pipe section and a first straight pipe wall located on a first end of the third pipe section, a minimum curvature radius of the third arc-shaped pipe wall is about 78 mm, the third arc-shaped pipe wall comprises a protrusion away from the fourth pipe wall, a maximum angle at the protrusion of the third arc-shaped pipe wall with respect to the first straight pipe wall is about 11° , and a height of the protrusion of the third arc-shaped pipe wall with respect to the first straight pipe wall is 50 mm; and the fourth pipe wall comprises a fourth arc-shaped pipe wall located on the first end of the third pipe section and a second straight pipe wall located on the first end of the first pipe section, a minimum curvature radius of the fourth arc-shaped pipe wall is about 746 mm, the fourth arc-shaped pipe wall comprises a protrusion away from the third arc-shaped pipe wall, and a maximum angle at the protrusion of the fourth arc-shaped pipe wall with respect to the second straight pipe wall is about 4°; and

the third pipe section comprises a fifth arc-shaped pipe wall and a sixth arc-shaped pipe wall, a minimum curvature radius of the fifth arc-shaped pipe wall is about 170 mm, a minimum curvature radius of the sixth arc-shaped pipe wall is about 73 mm.

In an embodiment, the two upper deck transition air ducts are symmetrically disposed vertically; and

concave surfaces of the first arc-shaped pipe walls and concave surfaces of the second arc-shaped pipe walls face a region between the two upper deck transition air ducts, concave surfaces of third arc-shaped pipe walls face the region between the two upper deck transition air ducts, a width of the protrusion of the fourth arc-shaped pipe wall is smaller at the first end of the third pipe section than at the first end of the first pipe section, concave surfaces of the fifth arc-shaped pipe walls and concave surfaces of the sixth arc-shaped pipe walls face the region between the two upper deck transition air ducts.

In an embodiment, where the first pipe section is connected with one of the two upper deck air outlets has a first cross section area, where the second pipe section is connected with first pipe section has a second cross section area, where the third pipe section is connected with the second pipe section has a third cross section area, and where the third pipe section is connected with one of the two upper deck air inlets has a fourth cross section area; and

the second cross section area is about 55%-about 70% of the first cross section area, the third cross section area is about 85%-about 95% of the second cross section area, and the fourth cross section area is about 85%-about 95% of the third cross section area.

In an embodiment, the upper deck main air duct corresponds to upper seats on the body of the double-deck vehicle, the upper deck main air duct comprises two upper deck side air ducts corresponding to seats disposed on two sides of the upper deck, the two upper deck side air ducts are respectively communicated with the two upper deck transition air ducts, and the two upper deck side air ducts comprise first upper deck air vents corresponding to the seats on two sides of the upper deck respectively; and

the two upper deck side air ducts comprise a first upper deck side air duct and a second upper deck side air duct, the first upper deck side air duct is located on a first side where a stair of the body of the double-deck vehicle is located, and a second upper deck air vent is disposed between adjacent first upper deck air vents of the second upper deck side air duct on a second side opposite to the stair.

In an embodiment, upper deck main air duct further comprises an upper deck front air duct corresponding to upper deck front seats, the upper deck front air duct is communicated with the two upper deck side air ducts, an upper deck front air vent is disposed on the upper deck front air duct and is a first adjustable air vent.

In an embodiment, in a front-rear direction of the body of the double-deck vehicle, a distance between the first upper deck air vents and a corresponding passenger face area of passengers in the seats is about 180 mm-about 250 mm.

In an embodiment, the air conditioning system further includes a cab air duct of a cab, and an evaporator comprising a cab return air vent facing the cab,

the evaporator is communicated with the air conditioner box and the cab air duct, the cab air duct extends to a top of the cab, and the cab air duct comprises a second adjustable air vent.

In an embodiment, the air conditioning system further includes two lower deck transition air ducts and two lower deck main air ducts, the air conditioner box has two lower deck air outlets, and the two lower deck main air ducts are respectively connected to the two lower deck air outlets through the two lower deck transition air ducts, and each of the two lower deck main air ducts comprises first lower deck air vents corresponding to lower deck seats; and

a second lower deck air vent corresponding to a door and disposed on the lower deck main air duct located on a side where the door is located, and the second lower deck air vent comprises one to three rows of strip-shaped air vents.

In an embodiment, the air conditioning system further includes an upper deck return air duct, the upper deck return air duct is communicated with the air conditioner box, the upper deck return air duct is provided with an upper deck return air vent, and the upper deck return air vent is located in a lower rear area of the upper deck.

In an embodiment, the air conditioning system further includes a lower deck return air duct, the lower deck return air duct is communicated with the upper deck return air duct, the lower deck return air duct comprises a lower deck return air vent located in an upper rear area of a lower deck of the body of the double-deck vehicle, and the lower deck return air vent comprises a vent switch device.

According to a second aspect of the present disclosure, there is provided a double-deck vehicle, the double-deck vehicle includes a body of the double-deck vehicle and the air conditioning system of the first aspect.

The present disclosure provides that each upper deck transition air duct is communicated with an upper deck air outlet and an upper deck air inlet. The inner wall of the upper deck transition air duct and the inner wall of the upper air outlet are in smooth transition, and the inner wall of the upper deck transition air duct and the inner wall of the upper deck air inlet are in smooth transition. The smooth transition can avoid the problems of pressure loss and uneven air speed during the process of air supply from the air conditioner box entering the upper deck main air duct, reduce the resistance of the upper deck transition air duct to the air supply from the air conditioner box to the upper deck main air duct, increase the air supply volume, improve the air supply efficiency of the air conditioning system, and make the air speed of the air sent into the car through the upper deck main air duct uniform to reduce noise.

Other features and advantages of the present disclosure will become clear through the detailed description of the embodiments of the present disclosure with reference to the accompanying drawings.

### BRIEF DESCRIPTION OF THE DRAWINGS

The drawings, which form a part of the description, describe embodiments of the present disclosure and, together with the description, are used to explain the principles of the present disclosure.

FIG. 1 is a first schematic structural diagram of an air conditioning system according to an embodiment of the present disclosure;

FIG. 2 a second schematic structural diagrams of an air conditioning system according to an embodiment of the present disclosure;

FIG. 3 is the bottom schematic view of an upper deck main air duct of an air conditioning system according to an embodiment of the present disclosure;

FIG. 4 is the side schematic view of an air conditioning system according to an embodiment of the present disclosure;

FIG. 5 is a partial enlarged schematic diagram;

FIG. 6 is the bottom schematic view of a lower deck main air duct of an air conditioning system according to an embodiment of the present disclosure; and

FIG. 7 is a schematic structural diagrams of a double-deck vehicle according to an embodiment of the present disclosure.

### DETAILED DESCRIPTION

Various embodiments of the present disclosure will now be described in detail with reference to the accompanying drawings. It should be noted that, unless stated otherwise, the relative arrangement of the components and steps, the numerical expressions, and numerical values set forth in these embodiments do not limit the scope of the present disclosure.

The following description of at least one embodiment is merely illustrative in nature and is not to limit the present disclosure, applications, or uses.

Techniques and apparatus known to those of ordinary skill in the relevant art may not be discussed in detail, but are to be considered a part of the specification where appropriate.

In all examples shown and discussed herein, any particular value should be examples only and not be limitation. Thus, other examples of the embodiments may have different values.

It should be noted that, like reference numbers and letters refer to like items in the following figures, and thus, once an item is defined in one figure, further discussion thereof may not be in subsequent figures.

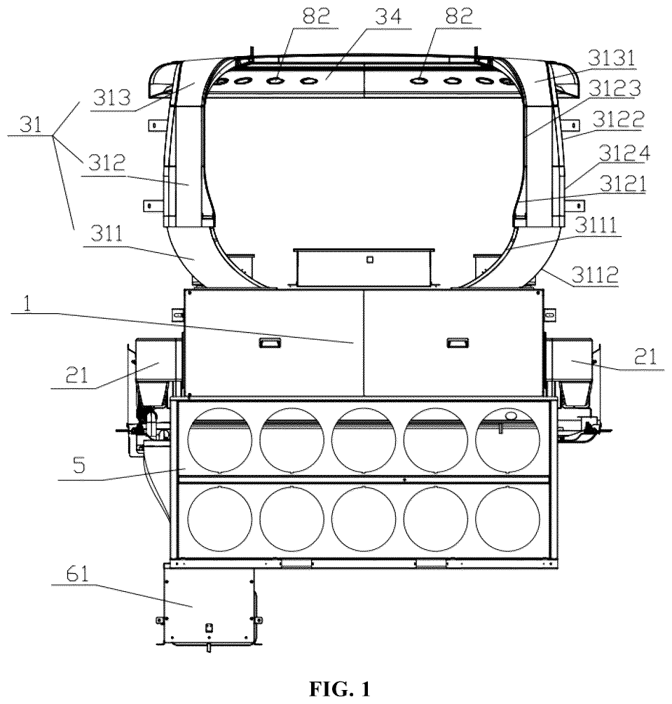

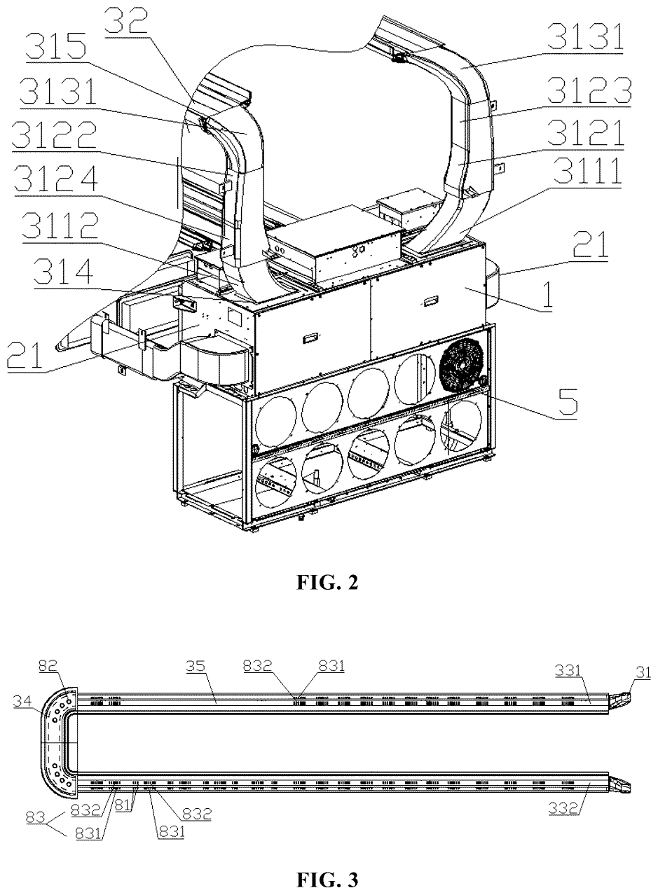

According to an embodiment of the present disclosure, there is provided an air conditioning system of a double-deck vehicle, as shown in FIGS. 1 to 7, including:

an air conditioner box 1, the air conditioner box 1 is arranged/disposed on the body of a double-deck vehicle, and the air conditioner box 1 is provided with two upper deck air outlets 314;

an upper deck main air duct 32 is arranged at the top of the upper deck of the double-deck vehicle body, the upper deck main air duct 32 is provided with two upper deck air inlets 315, and the upper deck air outlets 314 and the upper deck air inlets 315 are staggered in the horizontal direction;

two upper deck transition air ducts 31, each upper deck transition air duct 31 is communicated with one upper deck air outlet 314 and one upper deck air inlet 315;

the inner wall of the upper deck transition air duct 31 and the inner wall of the upper deck air outlet 314 are in smooth transition, and the inner wall of the upper deck transition air duct 31 and the inner wall of the upper deck air inlet 315 are in smooth transition. The upper deck air outlet 314 is an outlet, that supplies air from air conditioner box 1 to the upper deck transition air duct 31, and the inner wall of the upper deck air outlet 314 refers to the inner wall of the upper deck transition air duct 31. The inner wall of the upper deck air inlet 315 is the inner wall of the upper deck main air duct 32. Smooth transition makes the inner surface of the pipeline smooth and streamlined.

In the embodiment of the present disclosure, each upper deck transition air duct 31 is communicated with one upper deck air outlet 314 and one upper deck air inlet 315. The inner wall of the upper deck transition air duct 31 and the inner wall of the upper deck air outlet 314 are in smooth transition, which can avoid energy loss caused by the internal vortices in the upper deck transitional air duct 31 when the air conditioner box 1 supplies air to the upper deck transitional air duct 31. The inner wall of the upper deck transition air duct 31 and the inner wall of the upper deck air inlet 315 are in smooth transition, which can avoid energy loss caused by the internal vortices in the upper deck main air duct 32 when the air in the upper deck transition air duct 31 enters the upper deck main air duct 32. This may increase the air speed of the air in the vent of the upper deck main air duct 32.

Smooth transition can avoid the problem of pressure loss and the uneven wind speed during the process of air supply from air conditioner box 1 entering the upper deck main air duct 32, reduce the resistance of the upper deck transition air duct 31 to the air supply from air conditioner box 1 to the upper deck main air duct 32, increase the air supply volume, improve the air supply efficiency of the air conditioning system, make the air speed of the air sent into the car through the upper deck main air duct 32 uniform, and reduce noises.

In an embodiment, the air conditioner box 1 may be provided on the rear side or the front side of the double-deck vehicle body. Under the condition that the air conditioner box 1 is provided on the rear side of the double-deck vehicle body, the air conditioner box 1 is communicated with the upper deck transition air duct 31 through an upper deck air outlet 314. The upper deck air inlet 315 is positioned at the rear side of the double-deck vehicle body. Under the condition that the air conditioner box is arranged on the front side of the double-deck vehicle body, the upper deck air inlet 315 is positioned on the front side of the double-deck vehicle body.

In an embodiment, a condensing air sector 5 is provided below the air conditioner box 1, and the condensing air sector 5 is used for cooling the air conditioner box 1 and the evaporator 61 behind the driver.

The cross-sectional area A (m2) of the air duct on one side of the upper deck main air duct 32, the air output Q (m3/s) of the air conditioning system to one side of the upper deck air outlet, meet A >Q-5.5, which maximizes the utilization of the cavity of the air conditioning system. There are no electrical components such as speakers in the upper deck main air duct 32. The wire harness of the pipeline is concentrated in the area farthest from the vent of the upper deck main air duct 32. The inner side of the upper deck main air duct 32 is covered with insulation cotton, and the smoothness of the upper deck main air duct 32 is taken into account to avoid vortices in the flow field inside the upper deck main air duct 32 and to reduce flow resistance.

In an embodiment, as shown in FIG. 1-5, the cross section of the upper deck transition air duct 31 is rectangle or substantially rectangle, and the minimum curvature radius of each of four corners of the rectangle is about 25 mm.

The upper deck transition air duct 31 includes a first pipe section 311, a second pipe section 312 and a third pipe section 313, which are sequentially communicated, the first pipe section 311 is communicated with the upper deck air outlet 314, and the third pipe section 313 is communicated with the upper deck air inlet 315.

The first pipe section 311 is provided with a first arc-shaped pipe wall 3111 and a second arc-shaped pipe wall 3112, the first arc-shaped pipe wall 3111 and the second arc-shaped pipe wall 3112 are arranged oppositely to each other, the minimum curvature radius of the first arc-shaped pipe wall 3111 is about 6 mm, the minimum curvature radius of the second arc-shaped pipe wall 3112 is about 382 mm, and the bending directions of the first arc-shaped pipe wall 3111 and the second arc-shaped pipe wall 3112 face a same direction.

The second pipe section 312 is provided with a third pipe wall and a fourth pipe wall. The third pipe wall and the fourth pipe wall are arranged oppositely to each other, and the third pipe wall includes a third arc-shaped pipe wall 3121 located on one end (e.g., a first end) of the first pipe section 311 and a first straight pipe wall 3123 located on one end (e.g., a first end) of the third pipe section 313. The minimum curvature radius of the third arc-shaped pipe wall 3121 is about 78 mm. The third arc-shaped pipe wall 3121 has a protrusion that protrudes towards the direction away from the fourth arc-shaped pipe wall 3122, the maximum angle at the protrusion of the third arc-shaped pipe wall 3121 with respect to the first straight pipe wall is about 11°, and the height of the protrusion of the third arc-shaped pipe wall 3121 with respect to the first straight pipe wall is about 50 mm. The protrusion of the third arc-shaped pipe wall 3121 forms a concave structure consistent with the characteristics of the fluid on the upper deck transition air duct 31, so as to avoid forming low-speed vortices in the upper deck transition air duct 31.

The fourth pipe wall includes a fourth arc-shaped pipe wall 3122 located on one end of the third pipe section 313 and a second straight pipe wall 3124 located on one end of the first pipe section 311, the minimum curvature radius of the fourth arc-shaped pipe wall 3122 is about 746 mm. The fourth arc-shaped pipe wall 3122 has a protrusion that protrudes towards the direction away from the third arc-shaped pipe wall 3121, and the maximum angle at the protrusion of the fourth arc-shaped pipe wall 3122 with respect to the second straight pipe wall is about 4°

The third pipe section 313 is provided with a fifth arc-shaped pipe wall 3131 and a sixth arc-shaped pipe wall 3132. The minimum curvature radius of the fifth arc-shaped pipe wall 313 lis about 170 mm, the minimum curvature radius of the sixth arc-shaped pipe wall 3132 is about 73 mm, and the bending directions of the fifth arc-shaped pipe wall 3131 and the sixth arc-shaped pipe wall 3132 face a same direction. The structure of the third pipe section 313 effectively reduces the resistance of the air entering the upper deck main air duct 32 from the upper deck transition air duct 31. Compared with the related art, the resistance of the air entering the upper deck main air duct 32 is reduced by at least 23%. The present disclosure effectively enables the air entering the upper deck main air duct 32 to flow out at a uniform speed from the upper deck air outlet 314 of the upper deck main air duct 32, ensuring the uniformity of the wind speed of the air entering the vehicle, and avoiding the problem of wind resistance caused by adjusting the wind speed using air outlet covers and other methods.

In an embodiment of the present disclosure, the first pipe section 311, the second pipe section 312, and the third pipe section 313 form the upper deck transition air duct 31 with a streamline structure, so that the inner wall of the upper deck transition air duct 31 follows the flowing trend of the fluid. Therefore, the vortices in the cavity and energy loss are effectively reduced, the resistance of the upper deck transition air duct 31 to the wind is reduced, and the air supply efficiency of the air conditioning system is improved. The air conditioning system of the present disclosure can reduce the resistance of the upper deck transition air duct 31 to wind by at least 15% relative to the related art.

The cross section of the upper deck transition air duct 31 is rectangle including four sides and four corners, and each corner is an arc corner with the minimum curvature radius of about 25 mm. This can avoid the formation of vortices in the cavity and the energy loss between the adjacent pipe walls of the upper deck transition air duct 31. For example, each of the first pipe section 311, second pipe section 312, and third pipe section 313 has a cross-section of rectangular.

For example, the first pipe section 311 further includes two pipe walls disposed oppositely, the two pipe walls are disposed between the first arc-shaped pipe wall 3111 and the second arc-shaped pipe wall 3112 to form the first pipe section 311, and the cross section of the first pipe section 311 is rectangular.

For example, the second pipe section 312 further includes two pipe walls disposed oppositely, the two pipe walls are disposed between the third pipe wall and the fourth pipe wall to form the second pipe section 312, and the cross section of the second pipe section 312 is rectangular.

For example, the third pipe section 313 further includes two pipe walls disposed oppositely, the two pipe walls are disposed between the fifth arc-shaped pipe wall 3131 and the sixth arc-shaped pipe wall 3132 to form the third pipe section 313, and the cross section of the third pipe section 313 is rectangular.

In an embodiment, as shown in FIGS. 1 to 7, two upper deck transition air ducts 31 are symmetrically arranged.

The concave surfaces of the first arc-shaped pipe wall 3111 and the second arc-shaped pipe wall 3112 face towards the region between the two upper deck transition air ducts 31. The concave surface of third arc-shaped pipe wall 3121 faces towards the region between the two upper deck transition air ducts 31. The fourth arc-shaped pipe wall 3122 protrudes towards the outer side of the two upper deck transition air ducts 31 in the direction from the third pipe section 313 to the first pipe section 311, such that a height of the protrusion of the fourth arc-shaped pipe wall is smaller at the end of the third pipe section than at the end of the first pipe section. The fifth arc-shaped pipe wall 3131 and the sixth arc-shaped pipe wall 3132 bent towards the interior of the double-deck vehicle body, the concave surfaces of the fifth arc-shaped pipe wall 3131 and the sixth arc-shaped pipe wall 3132 face towards the interior of the double-deck vehicle body.

In an embodiment of the present disclosure, the two upper deck transition air ducts 31 are symmetrically arranged, so as to avoid obstructing the rear viewing glass 30 of the double-deck vehicle, to avoid affecting the viewing of the passenger from the rear viewing glass 30.

The structures of the first arc-shaped pipe wall 3111, the second arc-shaped pipe wall 3112, the third arc-shaped pipe wall 3121, the fourth arc-shaped pipe wall 3122, the fifth arc-shaped pipe wall 3131, and the sixth arc-shaped pipe wall 3132 can ensure the streamline structure of the upper deck transition air duct 31, and make the inner wall of the upper deck transition air duct 31 fit with the flowing trend of the wind, so that the vortices in the cavity formed by the air supply through the upper deck transition air duct 31 and the energy consumption loss are effectively reduced.

In an embodiment, the first pipe section 311 has a first cross-sectional area where it communicates with the upper deck air inlet 315, the second pipe section 312 has a second cross-sectional area where it communicates with the first pipe section 311, the third pipe section 313 has a third cross-sectional area where it communicates with the second pipe section 312, and the third pipe section 313 has a fourth cross-sectional area where it communicates with the upper deck air inlet 315.

The second cross-sectional area is about 55%-about 70% of the first cross-sectional area, the third cross-sectional area is about 85%-about 95% of the second cross-sectional area, and the fourth cross-sectional area is about 85%-about 95% of the third cross-sectional area. In the embodiment of the present disclosure, the cross-sectional areas of the upper deck transition air duct 31 are different at different positions, so that the streamlined upper deck transition air duct 31 can effectively avoid energy loss and vortices in the cavity.

In an embodiment, the upper deck main air duct 32 corresponds to the upper deck seat on the body of the double-deck vehicle, the upper deck main air duct 32 includes two upper deck side air ducts corresponding to the seats on both sides of the upper deck, each upper deck side air duct is communicated with one of the upper deck transition air ducts 31, and the two upper deck side air ducts are provided with the first upper deck air vents 83 corresponding to the seats on both sides of the upper deck. For example, the first upper deck air vent 83 can be a dispersion vent or an adjustable vent.

The two upper deck side air ducts include a first upper deck side air duct 331 and a second upper deck side air duct 332. The first upper deck side air duct 331 is located on one side where a stair of the double-deck vehicle body is located, and the first upper deck air vent 83 in the first upper deck side air duct 331 is staggered with the region where the stair of the double-deck vehicle body are located. In the second upper deck side air duct 332, a second upper deck air vent 81 is disposed between adjacent first upper deck air vents 83 and in the region of the double-deck vehicle body opposite to the stairs.

In the embodiment of the present disclosure, the first upper deck air vent 83 on the first upper deck side air duct 331 is staggered from the area where the double-deck vehicle body stairs are located, so there is no vent in a region 35 of the first upper deck side air duct 331 corresponding to the stairs of the double-deck vehicle body. This avoids the formation of clash when the low temperature air current of the lower deck of the vehicle flows upwards to the upper deck. Since the time that the passengers stay on the stairs is short, the comfort of the passengers is not affected, the air quantity of the air vents in other areas of the upper deck main air duct 32 can be effectively improved, and the thermal comfort of passengers on the upper deck is greatly improved.

In a side of the second upper deck side air duct 332, opposite to the region of the double-deck vehicle body stairs, there is a second upper deck air vent 81 between adjacent first upper deck air vents 83. Thus, the temperature of the side and the stairs area 23 can be uniform, and the air loss of a non-passenger area is reduced while the air of the seat area is ensured.

In an embodiment, the first upper deck air vent 83 includes an upper deck window air vent 831 and an upper deck corridor air vent 832, and the upper deck window air vent 831 is arranged corresponding to the upper deck window seat. For example, the upper deck window air vent 831 blows air toward the upper deck window seats. The upper deck corridor air vent 832 is arranged corresponding to the upper deck corridor seats. The upper deck corridor air vent 832 blows air toward the upper corridor. Each seat is provided with one vent. The upper deck window air vent 831 and the upper deck corridor air vent 832 can be a dispersion vent or an adjustable vent.

In an embodiment, in the front to rear direction of the double-deck vehicle body, the distance between the first upper deck air vent 83 and the corresponding passenger face region of the passengers in the seats is about 180 mm-about 250 mm.

For example, the front to rear direction of the vehicle is the X-axis direction, and the axial distance in the X-axis between the first upper deck air vent 83 and the corresponding passenger face region is about 180 mm to about 250 mm. The distance between the center of the air vent of each first upper deck air vent 83 and the face of a passenger is kept between about 180 mm and about 250 mm for the comfort of the passenger.

The upper deck window air vent 831 blows air to the window seats, and passengers at the upper deck window seats are affected by the thermal radiation from the skylight viewing glass, skylight side viewing glass, and side glass. The distribution of the upper deck window air vent 831 in present disclosure allows the air to blow directly onto the passenger seats near the window, effectively improving the comfort of the passengers near the window. The upper deck corridor air vent 832 allows the wind to blow closer to the corridor, and the upper deck corridor air vent 832 is configured to reduce the temperature of the heat at the upper deck skylight and improve the uniformity of the vehicle temperature.

In an embodiment, as shown in FIG. 1 to FIG. 3, the upper deck main air duct 32 further includes an upper deck front air duct 34 corresponding to the upper deck front seats. The upper deck front air duct 34 is communicated with the two upper deck side air ducts. The upper deck front air duct 34 is an annular air duct, an upper deck front air vent is arranged on the upper deck front air duct 34, and the upper deck front air vent is the first adjustable air vent 82. The first adjustable air vent 82 is an adjustable vent.

The upper deck front side of the vehicle is provided with glass, the annular air duct can adapt to the vehicle structure of the upper deck front side, the upper deck front air vent is a first adjustable air vent 82, and the air quantity of the air vent can be adjusted through the first adjustable air vent 82, so that the thermal comfort of passenger on the upper front side is improved. For example, there are eight first adjustable air vents 82 distributed on the circular air duct. Eight first adjustable air vents 82 are symmetrically distributed on both sides of the vehicle's corridor.

Eight first adjustable air vents 82 are distributed on the annular air duct to solve the problem of high radiation heat to passengers in front and high solar radiation heat to passenger on the window side, thereby improving passenger comfort.

In an embodiment, the cross-sectional area A (cm2) of the upper deck main air duct 32 is equal to the total area A (cm2) of the air vents on one side of the upper deck main air duct 32.

For example, the cross-sectional area of the first upper deck side air duct 331 is equal to the sum of the area of the first upper deck air vent 83 on the first upper deck side air duct 331 and half of the upper deck air vent on the upper deck front air duct 34 of the annular air duct.

In an embodiment, the air conditioning system further includes a cab air duct 63 and an evaporator 61.

The evaporator 61 is communicated with the air conditioner box 1, and the evaporator 61 can be cooled through the air conditioner box 1. The evaporator 61 is equipped with a cab return air vent 62 facing the cab. The evaporator 61 is communicated with a cab air duct 63, the cab air duct 63 extends to the top of the cab, and the cab air duct 63 is provided with a second adjustable air vent 72.

The air inside the cab enters the evaporator 61 through the cab return air vent 62, cools down, and is sent into the cab air duct 63. Then the air blows towards the cab through the second adjustable air vent 72.

For example, the air blown towards the driver's cabin through the second adjustable air vent 72 is directed towards the driver's head.

The cab air duct 63 is equipped with multiple second adjustable air vents 72, and the second adjustable air vent 72 located in the middle area is about 190 mm-about 210 mm away from the driver's nose tip in the X-axis direction. This can ensure the thermal comfort of the driver's area and solve the problem of the lower deck main air duct 2 being cut off by the stairs area 23 and unable to supply air to the cab.

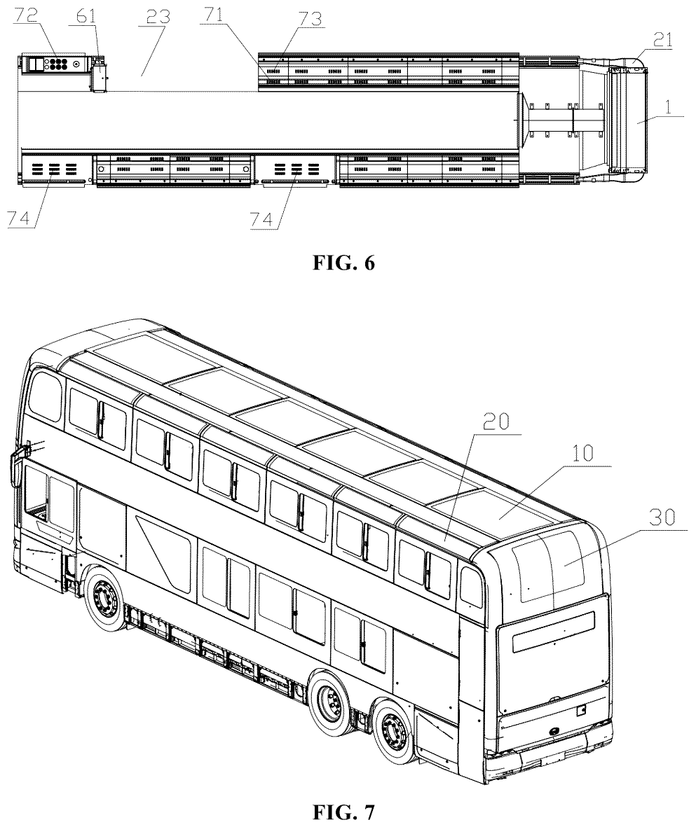

In an embodiment, as shown in FIG. 6, the air conditioning system further includes two lower deck transition air ducts 21 and two lower deck main air ducts 2. The air conditioner box 1 has two lower deck air outlets, and the two lower deck main air ducts 2 are respectively communicated with one lower deck air outlet through one lower deck transition air duct 21. The lower deck main air duct 2 is provided with a first lower deck air vent corresponding to the lower deck seat;

a second lower deck air vent 74 corresponding to the door located on the lower deck main air duct 2 located on one side of the vehicle door, the second lower deck air vent 74 comprises one to three rows of strip-shaped air vents.

In an embodiment of present disclosure, the first lower deck air vent supplies air to the lower deck seats. For example, the lower deck side air vent includes a lower deck window air vent 73 corresponding to the lower deck window seat, and a lower deck corridor air vent 71 corresponding to the lower deck corridor seat. The lower deck window air vent 73 and the lower deck corridor air vent 71 can be a dispersion vent or an adjustable vent. The air from the lower deck window air vent 73 blows to the lower deck passenger seats, while the air from the lower deck corridor air vent 71 blows to the lower corridor, providing good comfort for both standing and sitting passengers.

The second lower deck air vent 74 includes one to three rows of strip-shaped air vents, which can form an air curtain with a certain temperature difference and uniform flow velocity distribution at the car door, allowing passengers to feel cool as soon as they enter the car in summer, improving passenger thermal comfort.

In an embodiment, the cross-sectional area A (cm2) of the lower deck main air duct 2 set on the side of the vehicle door is equal to the total area A (cm2) of the lower deck window air vent 73, lower deck corridor air vent 71, and second lower deck air vent 74 on the lower deck main air duct 2 on the side of the vehicle door.

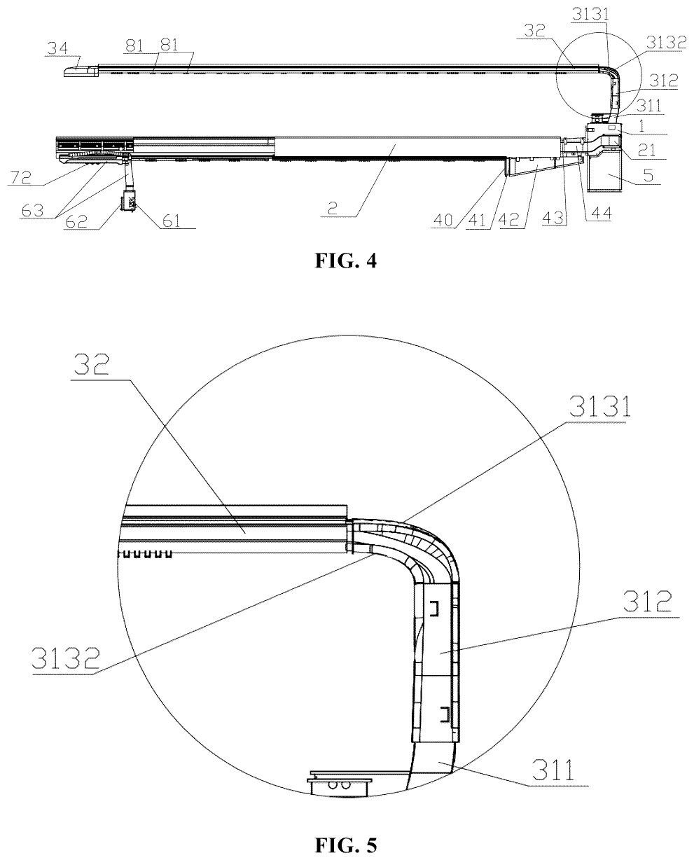

In an embodiment, as shown in FIG. 4, the air conditioning system further includes an upper deck return air duct 44, which is connected to the air conditioner box 1. The upper deck return air duct 44 has an upper deck return air vent 43 located in the rear bottom area of the upper deck of the double-deck vehicle body.

As shown in FIG. 7, when the area of the upper deck skylight viewing glass 10 and the skylight side viewing glass 20 of a double-deck vehicle is large and the heat is high in summer, the upper deck return air vent 43 is set in the rear bottom area of the upper deck of the vehicle, so that the lower temperature return air flows from the stairs area 23 to the upper deck return air vent 43, and then back to the air conditioner box 1, which can further reduce the temperature of the upper deck of the vehicle. The embodiment of the present disclosure is applicable to double-deck vehicle with a large skylight glass area and a high air conditioning system load on the upper deck.

In an embodiment, as shown in FIG. 4, the air conditioning system further includes a lower deck return air duct 42, which is communicated with an upper deck return air duct 44. The lower deck return air duct 42 has a lower deck return air vent 41, which is located in the rear top area of the lower deck of the vehicle. The lower deck return air vent 41 is equipped with a vent switch device 40.

The opening and closing of the lower deck return air vent 41 can be controlled by the vent switch device 40. According to the temperature situation of the upper deck, the lower deck return air vent 41 can be selected to be opened, and the lower deck return air duct 42 can be connected to the upper deck return air duct 44, so that the return air can be sent back to the air conditioner box 1 together from the upper deck return air duct 44.

According to another embodiment of the present disclosure, a double-deck vehicle is provided, including a double-deck vehicle body equipped with an air conditioning system of the double-deck vehicle as set forth in any one of the embodiments of the present disclosure.

The double-deck vehicle has the technical effects brought by the air conditioning system of the double-deck vehicle in the embodiments of the disclosure.

The vehicles in the present disclosure are all double-deck vehicles in present disclosure.

In the above embodiments, the differences between the embodiments are described in emphasis, and different optimization features between the embodiments can be combined to form a better embodiment as long as the differences are not contradictory, and further description is omitted here in consideration of brevity of the text.

Although some specific embodiments of the present disclosure have been described in detail by way of illustration, it should be understood by those skilled in the art that the above illustration is only for purposes of illustration and is not to limit the scope of the present disclosure. It will be appreciated by those skilled in the art that modifications may be made to the above embodiments without departing from the scope and spirit of the present disclosure. The scope of the present disclosure is defined by the appended claims.

### REFERENCE NUMERALS

1: air conditioner box; 10: skylight viewing glass; 20: skylight side viewing glass;

30: rear viewing glass; 5: condensing air sector;

2: lower deck main air duct; 21: lower deck transition duct; 23: stairs area; 31: upper deck transition duct; 311: first pipe section; 312: second pipe section;

313: third pipe section; 3111: first arc-shaped pipe wall; 3112: second arc-shaped pipe wall; 3121: third arc-shaped pipe wall; 3122: fourth arc-shaped pipe wall; 3123: first straight pipe wall; 3124: second straight pipe wall; 3131: fifth arc-shaped pipe wall; 3132: sixth arc-shaped pipe wall; 314: upper deck air outlets; 315: upper deck air inlets;

32: upper deck main air duct; 331: first upper deck side air duct; 332: second upper

deck side air duct; 34: upper deck front air duct; 35: first upper deck side air duct in the opposite region of the double-deck vehicle body stairs;

40: vent switch device; 41: lower deck return air vent; 42: lower deck return air duct; 43: upper deck return air vent; 44: upper deck return air duct;

61: evaporator; 62: cab return air vent; 63: cab air duct;

71: lower deck corridor air vent; 72: second adjustable air vent; 73: lower deck window air vent; 74: second lower deck air vent; and

81: second upper deck air vent; 82: first adjustable air vent; 83: first upper deck air vent; 831: upper deck window air vent; and 832: upper deck corridor air vent.

What is claimed is:

1. An air conditioning system for a double-deck vehicle, comprising:
an air conditioner box disposed on a body of the double-deck vehicle, and comprising two upper deck air outlets;
an upper deck main air duct disposed at a top of an upper deck of the body of the double-deck vehicle, the upper deck main air duct comprises two upper deck air inlets, and the two upper deck air outlets and the two upper deck air inlets staggered in a horizontal direction;
two upper deck transition air ducts, each of the two upper deck transition air ducts communicated with one of the two upper deck air outlets and one of the two upper deck air inlets; and
inner walls of the two upper deck transition air ducts being in smooth transition with inner walls of the two upper deck air outlets and inner walls of the two upper deck air inlets.

2. The air conditioning system according to claim 1, wherein
a cross section of each of the two upper deck transition air ducts is substantially a rectangle, and a minimum curvature radius of each of four corners of the rectangle is about 25 mm;
each of the two upper deck transition air ducts comprises a first pipe section, a second pipe section, and a third pipe section, the first pipe section is communicated with one of the two upper deck air outlets, and the third pipe section is communicated with one of the two upper deck air inlets;
the first pipe section comprises a first arc-shaped pipe wall and a second arc-shaped pipe wall opposite to each other, a minimum curvature radius of the first arc-shaped pipe wall is about 6 mm, a minimum curvature radius of the second arc-shaped pipe wall is about 382 mm;
the second pipe section comprises a third pipe wall and a fourth pipe wall opposite to each other, the third pipe wall comprises a third arc-shaped pipe wall located on a first end of the first pipe section and a first straight pipe wall located on a first end of the third pipe section, a minimum curvature radius of the third arc-shaped pipe wall is about 78 mm, the third arc-shaped pipe wall comprises a protrusion away from the fourth pipe wall, a maximum angle at the protrusion of the third arc-shaped pipe wall with respect to the first straight pipe wall is about 11°, and a height of the protrusion of the third arc-shaped pipe wall with respect to the first straight pipe wall is about 50 mm; and the fourth pipe wall comprises a fourth arc-shaped pipe wall located on the first end of the third pipe section and a second straight pipe wall located on the first end of the first pipe section, a minimum curvature radius of the fourth arc-shaped pipe wall is about 746 mm, the fourth arc-shaped pipe wall comprises a protrusion away from the third arc-shaped pipe wall, and a maximum angle at the protrusion of the fourth arc-shaped pipe wall with respect to the second straight pipe wall is about 4°; and
the third pipe section comprises a fifth arc-shaped pipe wall and a sixth arc-shaped pipe wall, a minimum curvature radius of the fifth arc-shaped pipe wall is about 170 mm, a minimum curvature radius of the sixth arc-shaped pipe wall is about 73 mm.

3. The air conditioning system according to claim 2, wherein
the two upper deck transition air ducts are symmetrically disposed vertically; and
concave surfaces of the first arc-shaped pipe walls and concave surfaces of the second arc-shaped pipe walls face a region between the two upper deck transition air ducts, concave surfaces of third arc-shaped pipe walls face the region between the two upper deck transition air ducts, a width of the protrusion of the fourth arc-shaped pipe wall is smaller at the first end of the third pipe section than at the first end of the first pipe section, concave surfaces of the fifth arc-shaped pipe walls and concave surfaces of the sixth arc-shaped pipe walls face the region between the two upper deck transition air ducts.

4. The air conditioning system according to claim 2, wherein
where the first pipe section is connected with one of the two upper deck air outlets has a first cross section area, where the second pipe section is connected with first pipe section has a second cross section area, where the third pipe section is connected with the second pipe section has a third cross section area, and where the third pipe section is connected with one of the two upper deck air inlets has a fourth cross section area; and
wherein the second cross section area is about 55%-about 70% of the first cross section area, the third cross section area is about 85%-about 95% of the second cross section area, and the fourth cross section area is about 85%-about 95% of the third cross section area.

5. The air conditioning system according to claim 1, wherein
the upper deck main air duct corresponds to upper seats on the body of the double-deck vehicle, the upper deck main air duct comprises two upper deck side air ducts corresponding to seats disposed on two sides of the upper deck, the two upper deck side air ducts are respectively communicated with the two upper deck transition air ducts, and the two upper deck side air ducts comprise first upper deck air vents corresponding to the seats on two sides of the upper deck respectively; and
the two upper deck side air ducts comprise a first upper deck side air duct and a second upper deck side air duct, the first upper deck side air duct is located on a first side where a stair of the body of the double-deck vehicle is located, and a second upper deck air vent is disposed between adjacent first upper deck air vents of the second upper deck side air duct on a second side opposite to the stair.

6. The air conditioning system according to claim 5, wherein the upper deck main air duct further comprises an upper deck front air duct corresponding to upper deck front seats, the upper deck front air duct is communicated with the two upper deck side air ducts, an upper deck front air vent is disposed on the upper deck front air duct and is a first adjustable air vent.

7. The air conditioning system according to claim 5, wherein in a front-rear direction of the body of the double-deck vehicle, a distance between the first upper deck air vents and a corresponding passenger face area of passengers in the seats is about 180 mm-about 250 mm.

8. The air conditioning system according to claim 1, further comprising a cab air duct of a cab, and an evaporator comprising a cab return air vent facing the cab, wherein
the evaporator is communicated with the air conditioner box and the cab air duct, the cab air duct extends to a top of the cab, and the cab air duct comprises a second adjustable air vent.

9. The air conditioning system according to claim 1, further comprising two lower deck transition air ducts and two lower deck main air ducts, wherein
the air conditioner box has two lower deck air outlets, and the two lower deck main air ducts are respectively connected to the two lower deck air outlets through the two lower deck transition air ducts, and each of the two lower deck main air ducts comprises first lower deck air vents corresponding to lower deck seats; and
a second lower deck air vent corresponding to a door and disposed on the lower deck main air duct located on a side where the door is located, and the second lower deck air vent comprises one to three rows of strip-shaped air vents.

10. The air conditioning system according to claim 1, further comprising an upper deck return air duct connected to the air conditioner box, wherein the upper deck return air duct has an upper deck return air vent located in a lower rear area of the upper deck.

11. The air conditioning system of claim 10, further comprising a lower deck return air duct communicated with the upper deck return air duct, wherein the lower deck return air duct comprises a lower deck return air vent located in an upper rear area of a lower deck of the body of the double-deck vehicle, and the lower deck return air vent comprises a vent switch device.

12. A double-deck vehicle, comprising a body of the double-deck vehicle and an air conditioning system, wherein the air conditioning system comprises:
an air conditioner box disposed on the body of the double-deck vehicle, and comprising two upper deck air outlets;
an upper deck main air duct disposed at a top of an upper deck of the body of the double-deck vehicle, the upper deck main air duct comprises two upper deck air inlets, and the two upper deck air outlets and the two upper deck air inlets staggered in a horizontal direction;
two upper deck transition air ducts, each of the two upper deck transition air ducts communicated with one of the two upper deck air outlets and one of the two upper deck air inlets; and
inner walls of the two upper deck transition air ducts being in smooth transition with inner walls of the two upper deck air outlets and inner walls of the two upper deck air inlets.

13. The double-deck vehicle according to claim 12, wherein
a cross section of each of the two upper deck transition air ducts is substantially a rectangle, and a minimum curvature radius of each of four corners of the rectangle is about 25 mm;
each of the two upper deck transition air ducts comprises a first pipe section, a second pipe section, and a third pipe section, the first pipe section is communicated with one of the two upper deck air outlets, and the third pipe section is communicated with one of the two upper deck air inlets;
the first pipe section comprises a first arc-shaped pipe wall and a second arc-shaped pipe wall opposite to each other, a minimum curvature radius of the first arc-shaped pipe wall is about 6 mm, a minimum curvature radius of the second arc-shaped pipe wall is about 382 mm;
the second pipe section comprises a third pipe wall and a fourth pipe wall opposite to each other, the third pipe wall comprises a third arc-shaped pipe wall located on a first end of the first pipe section and a first straight pipe wall located on a first end of the third pipe section, a minimum curvature radius of the third arc-shaped pipe wall is about 78 mm, the third arc-shaped pipe wall comprises a protrusion away from the fourth pipe wall, a maximum angle at the protrusion of the third arc-shaped pipe wall with respect to the first straight pipe wall is about 11°, and a height of the protrusion of the third arc-shaped pipe wall with respect to the first straight pipe wall is about 50 mm; and the fourth pipe wall comprises a fourth arc-shaped pipe wall located on the first end of the third pipe section and a second straight pipe wall located on the first end of the first pipe section, a minimum curvature radius of the fourth arc-shaped pipe wall is about 746 mm, the fourth arc-shaped pipe wall comprises a protrusion away from the third arc-shaped pipe wall, and a maximum angle at the protrusion of the fourth arc-shaped pipe wall with respect to the second straight pipe wall is about 4°; and
the third pipe section comprises a fifth arc-shaped pipe wall and a sixth arc-shaped pipe wall, a minimum curvature radius of the fifth arc-shaped pipe wall is about 170 mm, a minimum curvature radius of the sixth arc-shaped pipe wall is about 73 mm.

14. The double-deck vehicle according to claim 13, wherein
the two upper deck transition air ducts are symmetrically disposed vertically; and
concave surfaces of the first arc-shaped pipe walls and concave surfaces of the second arc-shaped pipe walls face a region between the two upper deck transition air ducts, concave surfaces of third arc-shaped pipe walls face the region between the two upper deck transition air ducts, a width of the protrusion of the fourth arc-shaped pipe wall is smaller at the first end of the third pipe section than at the first end of the first pipe section, concave surfaces of the fifth arc-shaped pipe walls and concave surfaces of the sixth arc-shaped pipe walls face the region between the two upper deck transition air ducts.

15. The double-deck vehicle according to claim 13, wherein
where the first pipe section is connected with one of the two upper deck air outlets has a first cross section area, where the second pipe section is connected with first pipe section has a second cross section area, where the third pipe section is connected with the second pipe section has a third cross section area, and where the third pipe section is connected with one of the two upper deck air inlets has a fourth cross section area; and
wherein the second cross section area is about 55%-about 70% of the first cross section area, the third cross section area is about 85%-about 95% of the second cross section area, and the fourth cross section area is about 85%-about 95% of the third cross section area.

16. The double-deck vehicle according to claim 12, wherein
the upper deck main air duct corresponds to upper seats on the body of the double-deck vehicle, the upper deck main air duct comprises two upper deck side air ducts corresponding to seats disposed on two sides of the upper deck, the two upper deck side air ducts are respectively communicated with the two upper deck transition air ducts, and the two upper deck side air ducts comprise first upper deck air vents corresponding to the seats on two sides of the upper deck respectively; and
the two upper deck side air ducts comprise a first upper deck side air duct and a second upper deck side air duct, the first upper deck side air duct is located on a first side where a stair of the body of the double-deck vehicle is located, and a second upper deck air vent is disposed between adjacent first upper deck air vents of the second upper deck side air duct on a second side opposite to the stair.

17. The double-deck vehicle according to claim 16, wherein the upper deck main air duct further comprises an upper deck front air duct corresponding to upper deck front seats, the upper deck front air duct is communicated with the two upper deck side air ducts, an upper deck front air vent is disposed on the upper deck front air duct and is a first adjustable air vent.

18. The double-deck vehicle according to claim 16, wherein in a front-rear direction of the body of the double-deck vehicle, a distance between the first upper deck air vents and a corresponding passenger face area of passengers in the seats is about180 mm-about250 mm.

19. The double-deck vehicle according to claim 12, wherein the air conditioning system further comprises a cab air duct of a cab, and an evaporator comprising a cab return air vent facing the cab, wherein
the evaporator is communicated with the air conditioner box and the cab air duct, the cab air duct extends to a top of the cab, and the cab air duct comprises a second adjustable air vent.

20. The double-deck vehicle according to claim 12, wherein the air conditioning system further comprises two lower deck transition air ducts and two lower deck main air ducts, wherein the air conditioner box has two lower deck air outlets, and the two lower deck main air ducts are respectively connected to the two lower deck air outlets through the two lower deck transition air ducts, and each of the two lower deck main air ducts comprises first lower deck air vents corresponding to lower deck seats; and
a second lower deck air vent corresponding to a door and disposed on the lower deck main air duct located on a side where the door is located, and the second lower deck air vent comprises one to three rows of strip-shaped air vents.
